(19) United States
(12) Patent Application Publication
(10) Pub. No.: US 2026/0350417 A1
(43) Pub. Date: Nov. 5, 2026

(54) METHOD AND SYSTEM FOR PROCESSING USER QUERIES USING LLMS ON RESOURCE CONSTRAINED DEVICES

(71) Applicant: L&T TECHNOLOGY SERVICES LIMITED, Chennai (IN)

(72) Inventors: VIKRAM SUBRAMANI, Krishnagiri (IN); SUDHIR BHADAURIA, Ahmedabad (IN)

(21) Appl. No.: 19/328,289

(22) Filed: Sep. 15, 2025

(30) Foreign Application Priority Data
May 2, 2025 (IN) 202541042552

(51) Int. Cl. G06N 3/10

(52) U.S. Cl. CPC G06N 3/10

(57) ABSTRACT

This disclosure relates to a method and system for processing user queries using Large Language Models (LLMs) on resource constrained devices. The method may include receiving, via a user interface, an LLM, a configuration file of the LLM, a weight file of the LLM, and hardware details of a user device. The method may further include determining a plurality of chunks of the LLM based on the architecture details of the LLM and the hardware details of the user device. The method may further include creating a plurality of LLM submodules and a corresponding plurality of partitioned weight files based on the plurality of chunks and the weight file. The method may further include sequentially processing, via one or more parallel processing threads, a user query through the plurality of LLM submodules using the corresponding plurality of partitioned weight files, to obtain an output.

### TECHNICAL FIELD

This disclosure relates generally to Large Language Models (LLMs), and more particularly to method and system for processing user queries using LLMs on resource constrained devices.

### BACKGROUND

Inference is a process of using a trained Artificial Intelligence (AI) model (such as a Large Language Model (LLM) or a deep neural network) to generate predictions or responses based on input user queries. However, AI models may have high computational and memory requirements. Additionally, AI models are faced with challenges associated with latency, power consumption, and memory footprint.

In the present state of the art, model compression and distributed computing techniques are used to address such challenges. Model compression techniques involve reduction of size of the AI model without compromizing accuracy of the AI model. By way of an example, the model compression techniques may include quantization, pruning, knowledge distillation, low rank factorization, and the like. However, the model compression techniques may face challenges, such as reduced accuracy, loss of generalization, and limited scalability.

The distributed computing techniques allow splitting of workload of the AI model across multiple devices to improve efficiency and to reduce latency. By way of an example, the distributed computing techniques may include model parallelism, data parallelism, pipeline parallelism, and the like. However, the distributed computing techniques may require more devices to accommodate the larger AI models (such as LLMs), leading to an increase in power consumption and complexity. Additionally, the distributed computing techniques may lead to a higher communication and synchronization overhead between the multiple devices. Additionally, the network latency between the multipe devices may offset computational gains. Also, transfer of intermediate outputs between the multipe devices may be a data communication bottleneck.

Thus, the present invention is directed to overcome one or more limitations stated above or any other limitations associated with the known arts.

### SUMMARY

In one embodiment, a method for processing user queries using Large Language Models (LLMs) on resource constrained devices is disclosed. In one example, the method may include receiving, via a user interface, an LLM, a configuration file of the LLM, a weight file of the LLM, and hardware details of a user device. The LLM may include a plurality of layers, and the configuration file may include architecture details for each of the plurality of layers of the LLM. The method may further include determining a plurality of chunks of the LLM based on the architecture details of the LLM and the hardware details of the user device. The each of the plurality of chunks may be a group of one or more layers of the plurality of layers. The method may further include creating a plurality of LLM submodules and a corresponding plurality of partitioned weight files based on the plurality of chunks and the weight file. Each of the plurality of partitioned weight files may include weights of the one or more layers of a corresponding submodule. The method may further include sequentially processing, via one or more parallel processing threads, a user query through the plurality of LLM submodules using the corresponding plurality of partitioned weight files, to obtain an output.

In one embodiment, a system for processing user queries using Large Language Models (LLMs) on resource constrained devices is disclosed. In one example, the system may include a processor and a computer-readable medium communicatively coupled to the processor. The computer-readable medium may store processor-executable instructions, which, on execution, may cause the processor to receive, via a user interface, an LLM, a configuration file of the LLM, a weight file of the LLM, and hardware details of a user device. The LLM may include a plurality of layers, and the configuration file may include architecture details for each of the plurality of layers of the LLM. The processor-executable instructions, on execution, may further cause the processor to determine a plurality of chunks of the LLM based on the architecture details of the LLM and the hardware details of the user device. Further, the each of the plurality of chunks may be a group of one or more layers of the plurality of layers. The processor-executable instructions, on execution, may further cause the processor to create a plurality of LLM submodules and a corresponding plurality of partitioned weight files based on the plurality of chunks and the weight file. Each of the plurality of partitioned weight files may include weights of the one or more layers of a corresponding submodule. The processor-executable instructions, on execution, may further cause the processor to sequentially process, via one or more parallel processing threads, a user query through the plurality of LLM submodules using the corresponding plurality of partitioned weight files, to obtain an output.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles.

FIG. 1 is a block diagram of an exemplary system for processing user queries using Large Language Models (LLMs) on resource constrained devices, in accordance with some embodiments.

FIG. 2 illustrates a functional block diagram of a memory of a computing device configured to process user queries using LLMs on resource constrained devices, in accordance with some embodiments.

FIG. 3 illustrates a flow chart of an exemplary process for processing user queries using LLMs on resource constrained devices, in accordance with some embodiments.

FIG. 4 illustrates a flow chart of an exemplary process for sequentially processing user queries through LLM submodules, in accordance with some embodiments.

FIG. 5 illustrates a flow chart of a detailed exemplary process for processing user queries using LLMs on resource constrained device, in accordance with some embodiments.

FIG. 6 illustrates a schematic diagram of inferencing through a chunked model interface, in accordance with some embodiments.

### DETAILED DESCRIPTION

Exemplary embodiments are described with reference to the accompanying drawings. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. It is intended that the following detailed description be considered as exemplary only, with the true scope and spirit being indicated by the following claims.

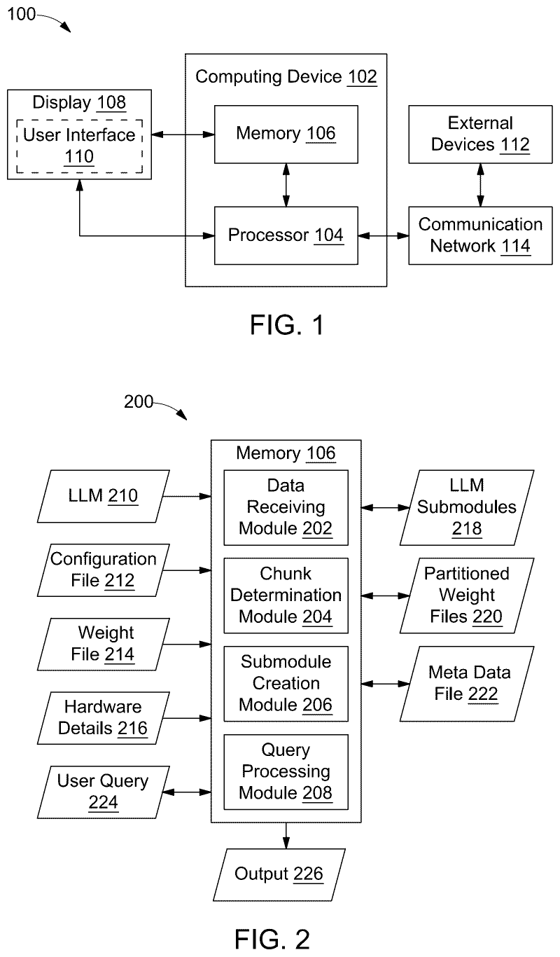

Referring now to FIG. 1, an exemplary system 100 for processing user queries using Large Language Models (LLMs) on resource constrained devices is illustrated, in accordance with some embodiments. The system 100 may include a computing device 102 (for example, a server, a desktop, a laptop, a netbook, a tablet, a smartphone, a mobile phone, or any other computing device). The computing device 102 may be configured to process user queries using an LLM on a resource constrained device. The resource constrained device may be a user device (not shown) communicatively coupled to the computing device 102. By way of an example, the user device may be, but may not be limited to, an edge device, an embedded system, and the like.

It should be noted that the user device may be a computing device with limited computational capacity deeming it difficult to efficiently deploy a complete LLM at once. In some embodiments, the computing device 102 may be the user device. In such embodiments, the computing device 102 may be configured to process the user queries using the LLM on itself, in accordance with some embodiments of the present disclosure. By way of an example, the LLMs may include, but may not be limited to, Generative Pre-trained Transformer (GPT), Gemini, Language Model for Dialogue Applications (LaMDA), Pathways Language Model (PaLM), BigScience Large Open-science Open-access Multilingual Language Model (BLOOM), Large Language Model Meta AI (Llama), Claude, Mistral 7B, Mixtral 8x7B, Mixtral 8x22B, etc.).

As will be described in greater detail in conjunction with FIGS. 2-6, the computing device 102 may receive, via a user interface, an LLM, a configuration file of the LLM, a weight file of the LLM, and hardware details of a user device. The LLM may include a plurality of layers. The configuration file may include architecture details for each of the plurality of layers of the LLM. The computing device 102 may further determine a plurality of chunks of the LLM based on the architecture details of the LLM and the hardware details of the user device. Each of the plurality of chunks may be a group of one or more layers of the plurality of layers. The computing device 102 may further create a plurality of LLM submodules and a corresponding plurality of partitioned weight files based on the plurality of chunks and the weight file. Each of the plurality of partitioned weight files may include weights of the one or more layers of a corresponding submodule. The computing device 102 may further sequentially process, via one or more parallel processing threads of the user device, a user query through the plurality of LLM submodules using the corresponding plurality of partitioned weight files, to obtain an output.

In some embodiments, the computing device 102 may include one or more processors 104 and a memory 106. The memory 106 may store instructions that, when executed by the one or more processors 104, cause the one or more processors 104 to process user queries through the plurality of LLM submodules using the corresponding plurality of partitioned weight files, to obtain an output, in accordance with aspects of the present disclosure. The memory 106 may also store various data (for example, configuration file, weight file, partitioned weight file, hardware details, and the like) that may be captured, processed, and/or required by the computing device 102.

The system 100 may further include a display 108. The system 100 may interact with a user via a user interface 110 accessible via the display 108. The system 100 may also include one or more external devices 112. In some embodiments, the computing device 102 may interact with the one or more external devices 112 over a communication network 114 for sending or receiving various data. The external devices 112 may include, but may not be limited to, the user device, a remote server, a digital device, or another computing system.

Referring now to FIG. 2, a functional block diagram 200 of the memory 106 of the computing device 102 configured to process user queries using Large Language Models (LLMs) on resource constrained device is illustrated, in accordance with some embodiments. FIG. 2 is explained in conjunction with FIG. 1. The memory 106 may include a data receiving module 202, a chunk determination module 204, a submodule creation module 206, and a query processing module 208.

The data receiving module 202 may receive an LLM 210, a configuration file 212 of the LLM 210, a weight file 214 of the LLM 210, and hardware details 216 of the user device through a user interface (such as the user interface 110). The LLM 210 may include the plurality of layers. Each of the plurality of layers may include one or more neurons and associated one or more weights. The configuration file 212 may include architecture details for each of the plurality of layers of the LLM 210. By way of an example, the architecture details may include, but may not be limited to, layer type details, layer parameter details, and layer dependency details. The data receiving module 202 may further extract the architecture details from the configuration file 212.

Further, the chunk determination module 204 may determine a plurality of chunks of the LLM 210 using the architecture details of the LLM 210, and the hardware details 216 of the user device. Each of the plurality of chunks may be a group of one or more layers of the plurality of layers. To determine the plurality of chunks, the chunk determination module 204 may determine an average resource utilization of each of the plurality of layers of the LLM 210. The average resource utilization, may include, for example, memory requirement, CPU/GPU consumption, and the like. The chunk determination module 204 may further compare the hardware details 216 with the average resource utilization. Based on the comparison and the architecture details of the LLM 210, the chunk determination module 204 may determine the plurality of chunks from the plurality of layers. It should be noted that each of the plurality of chunks may include a start processing position and an end processing position from the one or more layers.

Upon determining the plurality of chunks, the submodule creation module 206 may create a plurality of LLM submodules 218 and a corresponding plurality of partitioned weight files 220 through the plurality of chunks and the weight file 214, respectively. It should be noted that each of the plurality of submodules may be a functional unit of the LLM 210 that may be capable of processing data. The start processing position of a chunk may correspond to a layer that may receive an input for the submodule. The end processing position may correspond to a layer that may generate an output of the submodule. Each of the plurality of partitioned weight files 220 may include weights of the one or more layers of a corresponding submodule. Each of the plurality of partitioned weight files 220 may be obtained by partitioning of the weight file 214.

Additionally, the submodule creation module 206 may create a metadata file 222 for each of the plurality of chunks based on the architecture details. The meta data file 222 may include relationship data of each chunk with remaining of the plurality of chunks. In other words, the meta data file 222 may describe association (such as dependency) of each chunk with remaining of the chunks. The metadata file 222 may include information related to chunk(s) that may provide input data to each chunk and chunk(s) that may receive output data from each chunk.

Once the plurality of LLM submodules 218, the corresponding plurality of partitioned weight files 220 and the metadata file 222 are created, the LLM may be ready for inferencing stage on the user device. During the inferencing stage, the query processing module 208 may receive a user query 224 from the user interface. Further, the query processing module 208 may sequentially process, via one or more parallel processing threads, the user query 224 through the plurality of LLM submodules 218 using the corresponding plurality of partitioned weight files 220 to obtain an output 226.

In an embodiment, the one or more parallel processing threads may include the first processing thread and the second processing thread. To sequentially process the user query 224, the query processing module 208 may load a first submodule from the plurality of LLM submodules 218 via a first processing thread. It may be noted that loading the first submodule may include inputting the user query 224 to the first submodule and retrieving the first partitioned weight file corresponding to the first submodule. The query processing module 208 may then process, via the first processing thread, the user query 224 through the first submodule using the first partitioned weight file corresponding to the first submodule to obtain a first output. Contemporaneous to obtaining the first output, the query processing module 208 may further load, via a second processing thread, a second submodule from the plurality of LLM submodules 218. The contemporaneous loading of the second submodule may include inputting the first output to the second submodule and retrieving a second partitioned weight file corresponding to the second submodule. After inputting the first output to the second submodule, the query processing module 208 may unload the first submodule via the first processing thread. The query processing module 208 may contemporaneously process, via the second processing thread, the first output through the second submodule using a second partitioned weight file corresponding to the second submodule, to obtain a second output.

This may free the first processing thread to contemporaneously load a next submodule (after the second submodule) from the plurality of submodules. In this manner, each of the plurality of submodules may sequentially process the user query one by one. Thus, the user device (or the computing device 102) may load only one or more submodules of the LLM at a time rather than an entire LLM all at once. This may allow the inferencing stage to be optimally and efficiently executed on the user device (or the computing device 102). This is explained in greater detail in conjunction with FIG. 6.

It should be noted that all such aforementioned modules 202-208 may be represented as a single module or a combination of different modules. Further, as will be appreciated by those skilled in the art, each of the modules 202-208 may reside, in whole or in parts, on one device or multiple devices in communication with each other. In some embodiments, each of the modules 202-208 may be implemented as dedicated hardware circuit comprising custom application-specific integrated circuit (ASIC) or gate arrays, off-the-shelf semiconductors such as logic chips, transistors, or other discrete components. Each of the modules 202-208 may also be implemented in a programmable hardware device such as a field programmable gate array (FPGA), programmable array logic, programmable logic device, and so forth. Alternatively, each of the modules 202-208 may be implemented in software for execution by various types of processors (e.g., processor 104). An identified module of executable code may, for instance, include one or more physical or logical blocks of computer instructions, which may, for instance, be organized as an object, procedure, function, or other construct. Nevertheless, the executables of an identified module or component need not be physically located together but may include disparate instructions stored in different locations which, when joined logically together, include the module and achieve the stated purpose of the module. Indeed, a module of executable code could be a single instruction, or many instructions, and may even be distributed over several different code segments, among different applications, and across several memory devices.

As will be appreciated by one skilled in the art, a variety of processes may be employed for processing user queries using LLMs on resource constrained devices. For example, the exemplary system 100 and the associated computing device 102 may process user queries using LLMs on resource constrained devices discussed herein. In particular, as will be appreciated by those of ordinary skill in the art, control logic and/or automated routines for performing the techniques and steps described herein may be implemented by the system 100 and the associated computing device 102 either by hardware, software, or combinations of hardware and software. For example, suitable code may be accessed and executed by the one or more processors on the system 100 to perform some or all of the techniques described herein. Similarly, application specific integrated circuits (ASICs) configured to perform some, or all of the processes described herein may be included in the one or more processors on the system 100.

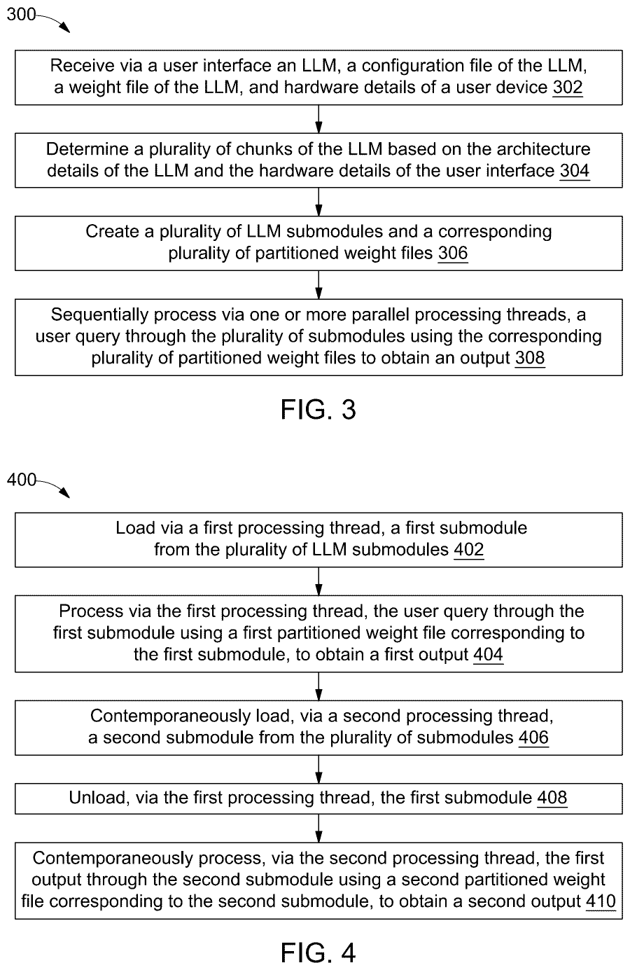

Referring now to FIG. 3, an exemplary process 300 for processing user queries using LLMs on resource constrained device is depicted via a flowchart, in accordance with some embodiments. FIG. 3 is explained in conjunction with FIGS. 1 and 2. The process 300 may be implemented by the computing device 102 of the system 100. The process 300 may include receiving, by a data receiving module (for example, the data receiving module 202), via a user interface, an LLM (for example, the LLM 210), a configuration file of the LLM (for example, the configuration file 212), a weight file of the LLM (for example, the weight file 214), and hardware details of a user device (for example, the hardware details 216), at step 302. The LLM may include the plurality of layers, and the configuration file may include architecture details for each of the plurality of layers of the LLM. The process 300 may further include extracting, by the data receiving module, the architecture details from the configuration file. The architecture details may include layer type details, layer parameters details, and layer dependencies details.

The process 300 may further include determining, by a chunk determination module (for example, the chunk determination module 204), a plurality of chunks of the LLM (for example, the plurality of chunk) based on the architecture details of the LLM and the hardware details of the user device, at step 304. The each of the plurality of chunks may be a group of one or more layers of the plurality of layers. To determine the plurality of chunks, the process 300 may include determining, by the chunk determination module, the average resource utilization of each of the plurality of layers of the LLM. The process 300 may include comparing, by the chunk determination module, the hardware details with the average resource utilization. After comparing, the process 300 may further include determining, by the chunk determination module, the plurality of chunks from the plurality of layers based on the comparison and the architecture details. Each of the plurality of chunks may include the starting processing position and the end processing position from the one or more layers.

The process 300 may include creating, by a submodule creation module (for example, the submodule creation module 206), a plurality of LLM submodules (for example, the plurality of LLM submodules 218), and a corresponding plurality of partitioned weight files (for example, the partitioned weight files 220), based on the plurality of chunks and the weight file, at step 306. Further, each of the plurality of partitioned weight files may include weights of the one or more layers of a corresponding submodule. The process 300 may further include creating, by the submodule creation module, a metadata file (for example, the metadata file 222) for each of the plurality of chunks based on the architecture details. The metadata file may include the relationship data of each chunk with remaining of the plurality of chunks. The process 300 may further include receiving, by a query processing module (for example, the query processing module 208), a user query (for example, the user query 224). Based on the user query, the query processing module may sequentially process, via one or more parallel processing threads, the user query through the plurality of LLM submodules using the corresponding plurality of partitioned weight files to obtain an output (for example, the output 226), at step 308. This is explained in greater detail in conjunction with FIG. 4.

Referring now to FIG. 4, an exemplary process 400 for sequentially processing user queries through LLM submodules is depicted via a flowchart, in accordance with some embodiments. FIG. 4 is explained in conjunction with FIGS. 1, 2, and 3. The process 400 may include loading, by a query processing module (for example, the query processing module 208), via the first processing thread, the first submodule from a plurality of LLM submodules (for example, the LLM submodules 218), at step 402. To load the first submodule, the process 400 may include inputting, by the query processing module, a user query (for example, the user query 224) to the first submodule. The process 400 may further include retrieving, by the query processing module, the first partitioned weight file corresponding to the first submodule. The process 400 may further include processing, by the query processing module, via the first processing thread, the user query through the first submodule using the first partitioned weight file corresponding to the first submodule, to obtain the first output, at step 404.

The process 400 may further include contemporaneously loading, by the query processing module, via the second processing thread, the second submodule from the plurality of LLM submodules, at step 406. The one or more parallel processing threads may include the first processing thread and the second processing thread. To contemporaneously load the second submodule, the process 400 may include inputting, by the query processing module, the first output to the second submodule. The process 400 may further include retrieving, by the query processing module, the second partitioned weight file corresponding to the second submodule. The process 400 may further include unloading, by the query processing module, via the first processing thread, the first submodule, at step 408. The process 400 may further include contemporaneously processing, by the query processing module, via the second processing thread, the first output through the second submodule using the second partitioned weight file corresponding to the second submodule, to obtain the second output, at step 410.

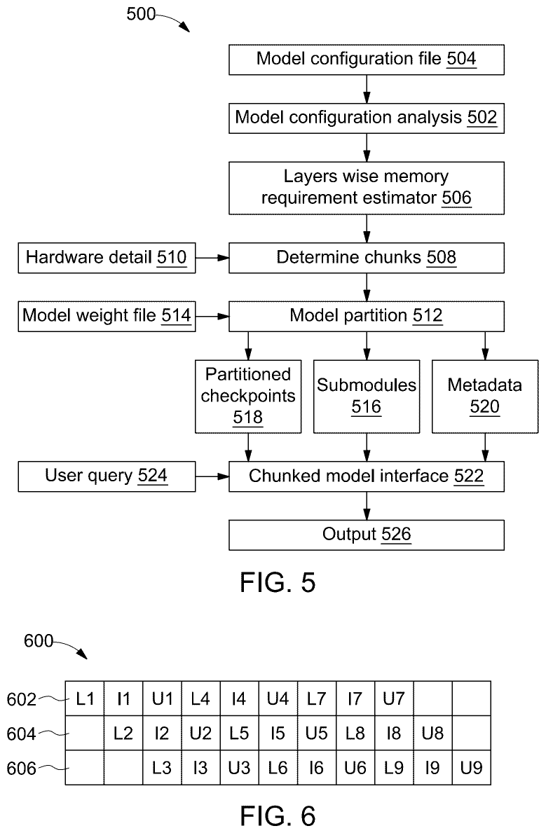

Referring now to FIG. 5, a detailed exemplary process 500 for processing user queries using LLMs on resource constrained devices, via a flowchart, in accordance with some embodiments. FIG. 5 is explained in conjunction with FIGS. 1,2,3, and 4. The process 500 may include a step 502 for model configuration analysis. The model configuration analysis may include extracting, by the data receiving module 202, model architecture (i.e., architecture details, for example, the layer type details, the layer parameters details, and the layer dependency details) corresponding to an AI model (such as the LLM 210) using a model configuration file 504 (analogous to the configuration file 212) of the AI model.

By way of an example, the AI model may be a Llama2 7B model. The Llama2 7B model may include a plurality of layers, such as an attention layer and an MLP layer. The attention layer may include four linear projection layers—‘q_proj’, ‘k_proj’, ‘v_proj’, and ‘o_proj’. Similarly, the MLP layer may include three linear projection layers—‘gate_proj’, ‘up_proj’, and ‘down_proj’. Further, the model configuration file 504 for Llama2 7B may include metadata about AI model specifications, such as, but not limited to, architecture details of the AI model. The model configuration file 504 for Llama2 7B may be used for model/layer identification (i.e., model configuration analysis). For the model/layer identification, the data receiving module 202 may identify major components, such as embedding layers, attention heads, feedforward layers, the number of layers (blocks), hidden size, and intermediate size. For Llama 2 7B, the major components may include embedding layers (32000,4096), 32 transformer blocks (each with multi-head attention and feedforward network, (attention layer hidden (size=4096), attention head (number=32), MLP intermediate (size=11008)), and an output layer (4096, 32000).

The process 500 may further include a step 506 for layer-wise memory requirement estimation. The layer-wise memory requirement estimation may include. computing, by the chunk determination module 204, a memory requirement (i.e., the average resource utilization) for each of the plurality of layers of the AI model. In an embodiment, the chunk determination module 204 may estimate GPU memory usage for each layer based on the parameter count (i.e., number of neurons) and the data type (for example, integer 8-bit, float 32-bit, float 64-bit, etc.). The memory usage may be estimated using equation (1).

Memory usage=number of parameters*precision (1)

In continuation of the above example, the q projection layer (i.e., ‘q_proj’ layer) of the attention layer may include 4096*4096 neurons (i.e., 16,777,216 parameters). Thus, the memory requirement to load the q projection layer (float 32-bit data type) may be about 64 MB (16777216*32 bits=536870912 bits≈64 MB). Additionally, to store output, the memory requirement may be about 16 kB (4096*32 bits=131072 bits≈16 kB).

The process 500 may further include a step 508 for determining the plurality of chunks of the AI model. The chunk determination module 204 may receive hardware details 510 (analogous to the hardware details 216) of the user device. Further, the chunk determination module 204 may determine the number of chunks and their size (i.e., the start processing point and the end processing point) based on the memory requirement of each layer and the hardware details 510. It should be noted that the start processing point correspond to a starting layer in the chunk and the end processing point may correspond to an ending layer in the chunk. In an embodiment, each of the plurality of chunks may be of same size. The chunk determination module 204 may ensure that the chunks align with computational dependencies and efficiency (i.e., the hardware details 510 of the user device).

In an embodiment, a maximum number of layers for a chunk may be determined based on the GPU memory capacity. In an embodiment, initially, a batch may be formed from the layers based on a number of parallel processing threads. Each batch may include one or more chunks. The number of chunks in a batch may be equal to the number of the parallel processing threads. For example, when there are 3 parallel processing threads, each batch may include three chunks. The memory requirement for each chunk may be than or equal to the total available hardware memory (obtained from the hardware details 510). First, the number of layers for each batch may be determined based on the total hardware memory and the estimated memory requirement per layer. Then, the layers may be evenly divided into a predefined number of chunks (for example, three chunks). It should be noted that the corresponding chunks from each batch have the same memory requirements. For example, the AI model may be divided into 3 batches of 3 chunks each. During inferencing, the first chunk of second batch (i.e., the fourth chunk overall) may be processed after the first chunk of first batch (i.e., the first chunk overall) in the same parallel processing thread. Therefore, both the first chunk and the second chunk must have the same (or similar) memory requirements.

Further, the process 500 may include a step 512 for model partition. that the submodule creation module 206 may receive a model weight file 514 (analogous to the weight file 214). For partitioning the model, the submodule creation module 206 may create submodules 516 (i.e., the plurality of LLM submodules) based on the determined chunks. Further, the submodule creation module 206 may split the model weight file 514 into partitioned checkpoints 518 (analogous to the plurality of partitioned weight files 220) corresponding to the submodules 516. Additionally, the submodule creation module 206 may generate a metadata file 520 (analogous to the metadata file 222) describing chunk relationships and reassembly. Thus, based on the chunk determination, submodules for the determined chunks of the AI model may be created and the model weight file may be partitioned.

The process 500 may include a step 522 for implementing the chunked model interface. The chunked model interface may include the submodules 516, the corresponding partitioned checkpoints 518, and the metadata file 520. The chunked model interface may be implemented on the computing device 102 or on another resource constrained device (such as the user device). During an inferencing stage, a user query 524 (i.e., the user query) may be received by the chunked model interface. Further, the process 500 may include dynamically loading only relevant submodules at a time to obtain an output 526. Thus, the inference stage may be executed in a memory-efficient way.

Referring now to FIG. 6, a schematic diagram 600 of inferencing through a chunked model interface is illustrated, in accordance with some embodiments. FIG. 6 is explained in conjunction with FIG. 5. By way of an example, an AI model may be split into nine submodules, and each submodule may be processed in chunks through three parallel processing threads (i.e., a first parallel processing thread 602, a second parallel processing thread 604, and a third parallel processing thread 606). For each submodule, there may be three processing stages. A first stage may correspond to loading, a second stage may correspond to inference, and a third stage may correspond to unloading. It may be noted that a user query (such as, the user query 524) may be received in a chunked model interface. It may be noted that the user query may be processed through the three parallel processing threads.

Initially, upon receiving the user query, at a step L1, a first submodule may be loaded in the first processing thread 602. Then, at a step I1, the first submodule may process (or inference) the user query in the first processing thread 602 to obtain a first output. Simultaneously, at a step L2, a second submodule may be loaded in the second processing thread 604. Here, the first output may be provided to the second submodule. Then, at a step U1, the first submodule may be unloaded in the first processing thread 602. Simultaneously, at step I2, the second submodule may process (or inference) the first output in the second processing thread 604. It is to be noted that each inference step may be dependent on the output of a previous inference step (for example, input for the step I2 is the first output obtained from the step I1). Simultaneously, at step L3, a third submodule may be loaded in the third processing thread 606. Thus, the steps U1, I2, and L3 may be performed parallelly through the first processing thread 602, the second processing thread 604, and the third processing thread 606, respectively. A similar order of steps may be repeated for next batches (i.e., chunks 4-6, and so on).

Advantageously, the techniques described in the present disclosure provide for parallelization. Each row ensures all three processes are executing simultaneously. Further, the techniques provide minimized idle states. As described in the above example, six idle states ensure inference is continuously fed with data. Additionally, the techniques maintain an optimized dependency handling. Every inference step takes input from the previous inference step to maintain correctness. Further, the techniques optimize the load distribution. As described in the above example, the AI model is split into three submodules per batch to maximize memory utilization.

In light of the above-mentioned advantages and the technical advancements provided by the disclosed method and system, the claimed steps as discussed above are not routine, conventional, or well understood in the art, as the claimed steps enable the following solutions to the existing problems in conventional technologies. Further, the claimed steps clearly bring an improvement in the functioning of the device itself as the claimed steps provide a technical solution to a technical problem.

The specification has described method and system for processing user queries using LLMs on resource constrained devices. The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope and spirit of disclosed embodiments being indicated by the following claims.

What is claimed is:

1. A method for processing user queries using Large Language Models (LLMs) on resource constrained devices, the method comprising:
receiving, by a processor via a user interface, an LLM, a configuration file of the LLM, a weight file of the LLM, and hardware details of a user device, wherein the LLM comprises a plurality of layers, and wherein the configuration file comprises architecture details for each of the plurality of layers of the LLM;
determining, by the processor, a plurality of chunks of the LLM based on the architecture details of the LLM and the hardware details of the user device, wherein the each of the plurality of chunks is a group of one or more layers of the plurality of layers;
creating, by the processor, a plurality of LLM submodules and a corresponding plurality of partitioned weight files based on the plurality of chunks and the weight file, wherein each of the plurality of partitioned weight files comprises weights of the one or more layers of a corresponding submodule; and
sequentially processing, by the processor via one or more parallel processing threads, a user query through the plurality of LLM submodules using the corresponding plurality of partitioned weight files, to obtain an output.

2. The method of claim 1, comprising extracting the architecture details from the configuration file, wherein the architecture details comprise layer type details, layer parameters details, and layer dependency details.

3. The method of claim 1, comprising creating a metadata file for each of the plurality of chunks based on the architecture details, wherein the metadata file comprises relationship data of each chunk with remaining of the plurality of chunks.

4. The method of claim 1, wherein sequentially processing the user query through the plurality of LLM submodules comprises:
loading, via a first processing thread, a first submodule from the plurality of LLM submodules,
processing, via the first processing thread, the user query through the first submodule using a first partitioned weight file corresponding to the first submodule, to obtain a first output;
contemporaneously loading, via a second processing thread, a second submodule from the plurality of LLM submodules, wherein the one or more parallel processing threads comprise the first processing thread and the second processing thread;
unloading, via the first processing thread, the first submodule; and
contemporaneously processing, via the second processing thread, the first output through the second submodule using a second partitioned weight file corresponding to the second submodule, to obtain a second output.

5. The method of claim 4, wherein:
loading the first submodule comprises:
inputting the user query to the first submodule; and
retrieving the first partitioned weight file corresponding to the first submodule, and
contemporaneously loading the second submodule comprises:
inputting the first output to the second submodule; and
retrieving the second partitioned weight file corresponding to the second submodule.

6. The method of claim 1, wherein determining the plurality of chunks of the LLM comprises:
determining an average resource utilization of each of the plurality of layers of the LLM;
comparing the hardware details with the average resource utilization; and
determining the plurality of chunks from the plurality of layers based on the comparison and the architecture details, wherein each of the plurality of chunks comprises a start processing position and an end processing position from the one or more layers.

7. A system for processing user queries using Large Language Models (LLMs) on resource constrained devices, the system comprising:
a processor; and
a memory communicatively coupled to the processor, wherein the memory stores processor instructions, which when executed by the processor, cause the processor to:
receive, via a user interface, an LLM, a configuration file of the LLM, a weight file of the LLM, and hardware details of a user device, wherein the LLM comprises a plurality of layers, and wherein the configuration file comprises architecture details for each of the plurality of layers of the LLM;
determine a plurality of chunks of the LLM based on the architecture details of the LLM and the hardware details of the user device, wherein the each of the plurality of chunks is a group of one or more layers of the plurality of layers;
create a plurality of LLM submodules and a corresponding plurality of partitioned weight files based on the plurality of chunks and the weight file, wherein each of the plurality of partitioned weight files comprises weights of the one or more layers of a corresponding submodule; and
sequentially process, via one or more parallel processing threads, a user query through the plurality of LLM submodules using the corresponding plurality of partitioned weight files, to obtain an output.

8. The system of claim 7, wherein the processor-executable instructions, on execution, cause the processor to:
extract the architecture details from the configuration file, wherein the architecture details comprise layer type details, layer parameters details, and layer dependency details.

9. The system of claim 7, wherein the processor-executable instructions, on execution, cause the processor to:
create a metadata file for each of the plurality of chunks based on the architecture details, wherein the metadata file comprises relationship data of each chunk with remaining of the plurality of chunks.

10. The system of claim 7, wherein to sequentially process the user query through the plurality of LLM submodules, the processor instructions, on execution, cause the processor to:
load via a first processing thread, a first submodule from the plurality of LLM submodules,
process via the first processing thread, the user query through the first submodule using a first partitioned weight file corresponding to the first submodule, to obtain a first output;
contemporaneously load via a second processing thread, a second submodule from the plurality of LLM submodules, wherein the one or more parallel processing threads comprise the first processing thread and the second processing thread;
unload via the first processing thread, the first submodule; and
contemporaneously process, via the second processing thread, the first output through the second submodule using a second partitioned weight file corresponding to the second submodule, to obtain a second output.

11. The system of claim 10, wherein:
to load the first submodule, the processor instructions, on execution, cause the processor to:
input the user query to the first submodule; and
retrieve the first partitioned weight file corresponding to the first submodule; and
to contemporaneously load the second submodule, the processor instructions, on execution, cause the processor to:
input the first output to the second submodule; and
retrieve the second partitioned weight file corresponding to the second submodule.

12. The system of claim 7, wherein to determine the plurality of chunks of the LLM, the processor instructions, on execution, cause the processor to:
determine an average resource utilization of each of the plurality of layers of the LLM;
compare the hardware details with the average resource utilization; and
determine the plurality of chunks from the plurality of layers based on the comparison and the architecture details, wherein each of the plurality of chunks comprises a start processing position and an end processing position from the one or more layers.
